(19) United States
(12) Patent Application Publication
(10) Pub. No.: US 2010/0329606 A1
(43) Pub. Date: Dec. 30, 2010

(54) LATERAL GUIDE OPTICAL FIBER

(76) Inventor: LI-CHEN WANG, TAINAN CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/752,457

(22) Filed: Apr. 1, 2010

(30) Foreign Application Priority Data
Jun. 24, 2009 (TW) 098211370

(51) Int. Cl. G02B 6/34

(52) U.S. Cl. 385/36

(57) ABSTRACT

A lateral guide optical fiber is revealed. The lateral guide optical fiber includes a transparent optical fiber body covered by a refraction layer and a reflector connected with one side of the optical fiber body. Thereby after light emitted into the optical fiber body from one end thereof, it is projected onto the refraction layer and then is refracted downward to be gathered onto the reflector. Then the light gathered is reflected by the reflector and is projected out. Thus the light intensity and uniformity of the optical fiber are increased dramatically by the light gathering and light reflection.

### BACKGROUND OF THE INVENTION

1. Fields of the invention

The present invention relates to an optical fiber, especially to a lateral guide optical fiber in which a transparent optical fiber body is covered by a refraction layer and a reflector is connected with one side of the optical fiber body. Thus light is reflected after being gathered so as to increase light intensity and uniformity of the optical fiber significantly.

2. Descriptions of Related Art

Generally, optical fibers have a plurality of advantages such as resistance to damages, impervious to water, high temperature resistance, and low heat generation. Thus optical fibers have been widely used in light and signal transmission. Moreover, the optical fibers provide good flexibility, plasticity and easy-shaped and modified appearance so that it is also widely applied to billboards, exit signs etc for illumination.

However, after light emitted from a light source into one end of the optical fiber, part of the optical fiber near the light source provides light with highest intensity. The light intensity generally decreases with increasing distance from the light source and nearly no light at the rear end of the optical fiber. When the optical fibers are used in ornaments or billboards, they have shortcomings of insufficient and non-uniform light intensity. Once the optical fibers are bent or curved, the light attenuation is more severe. The insufficient and non-uniform light intensity of the optical fiber cause a concern for the safety once the optical fiber is used in the public safety field such as exit signs.

Thus there is a need to have a novel design of the optical fiber that overcomes shortcomings of the optical fiber available now such as insufficient intensity and non-uniformity light.

### SUMMARY OF THE INVENTION

Therefore it is a primary object of the present invention to provide a lateral guide optical fiber that gathers light effectively and reflects the gathered light so as to improved light intensity and light uniformity significantly.

In order to achieve above object, a lateral guide optical fiber of the present invention includes an optical fiber body that is a transparent entity, a refraction layer that covers around the optical fiber body, and a reflector that is an opaque entity and is connected with one side of the optical fiber body.

Thereby after light being emitted into the optical fiber body from one end thereof, it is projected onto the refraction layer. The projected light is then refracted downward to be gathered onto the reflector. Then the gathered light is reflected by the reflector and is projected out. Thus the light rays are gathered, reflected and projected out. Therefore, the light intensity and uniformity of the optical fiber are increased dramatically.

Moreover, the present invention further includes at least two reflectors connected on lateral sides of the optical fiber so as to improve light reflection effect and further increase the light intensity and uniformity of the optical fiber.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a front cross sectional view of an embodiment according to the present invention;

FIG. 3 is a side cross sectional view of an embodiment according to the present invention;

FIG. 4 is a schematic drawing showing woven filamentous optical fibers according to the present invention;

FIG. 5 is a schematic drawing showing a final product made from filamentous optical fibers according to the present invention;

FIG. 6 is a side cross sectional view of an embodiment of an optical fiber body in a rectangular shape;

FIG. 7 is a side cross sectional view of an embodiment of an optical fiber body in a hexagonal shape;

FIG. 8 is a side cross sectional view of an embodiment of an optical fiber body in a triangular shape;

FIG. 9 is a side cross sectional view of another embodiment according to the present invention;

FIG. 10 is a side cross sectional view of a further embodiment according to the present invention;

FIG. 11 is a side cross sectional view of a further embodiment according to the present invention;

FIG. 12 is a schematic drawing showing a further embodiment according to the present invention.

### DETAILED DESCRIPTION OF THE PREFERRED EMBODIMENT

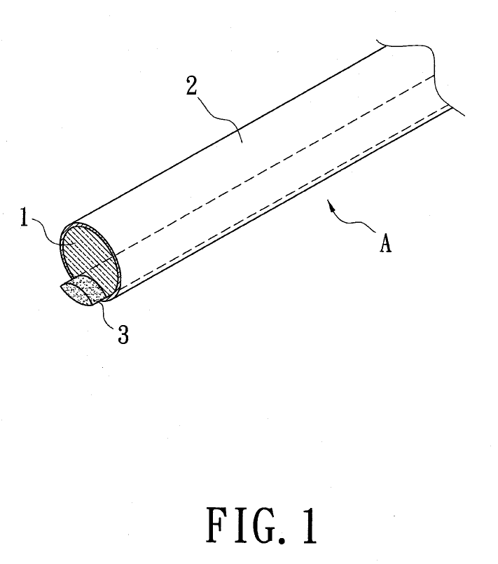

Refer to FIG. 1, an optical fiber A according to the present invention includes an optical fiber body 1, a refraction layer 2 and a reflector 3.

The optical fiber body 1 is a transparent entity made from polystyrene (PS), polymethyl methacrylate (PMMA), or polycarbonate (PC) while the refraction layer 2 made from polyvinylidene fluoride (PVDF) covers around the optical fiber body 1. As to the reflector 3, it is an opaque entity made from polymethyl methacrylate (PMMA) and is connected with one side of the optical fiber body 1. The other side of the reflector 3 is convex toward an inside of the optical fiber body 1.

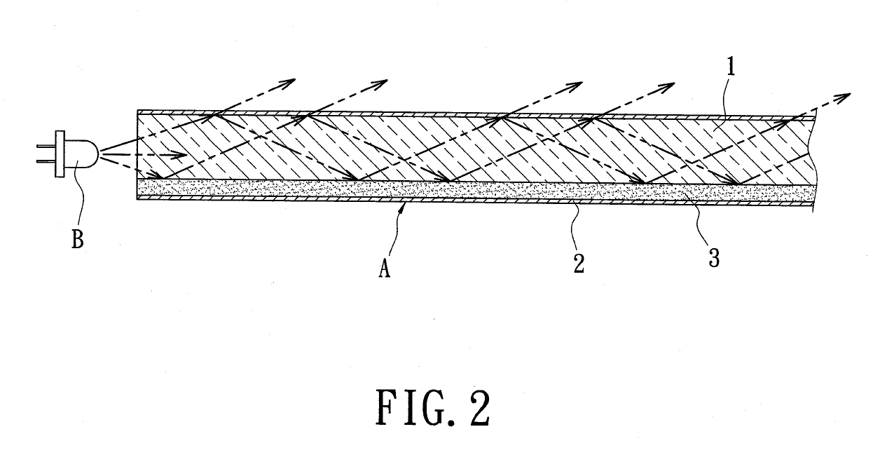

As shown in FIG. 2, while in use, a light emitting device B is set on one end of the optical fiber. Light emitted from the light emitting device B enters the optical fiber body 1 through one end of the optical fiber body 1. When the light entered the optical fiber body 1 is projected to the refraction layer 2 around the optical fiber body 1, part of light passes through the optical fiber and some other part of light is refracted from the refraction layer 2 into the reflector 3 to be concentrated on the reflector 3.

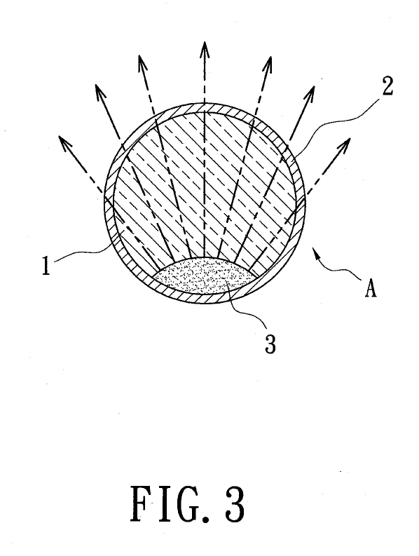

Refer to FIG. 3, light concentrated to the reflector 3 is reflected by the reflector 3 so as to generate scattering light. Thus by concentration and reflection of large amount of light, light intensity and light uniformity of the optical fiber A are dramatically increased.

Thereby when the optical fiber A is applied to billboards or ornaments, both aesthetic value of the ornaments and the billboard resolution are improved due to high intensity and high uniformity of the optical fiber A.

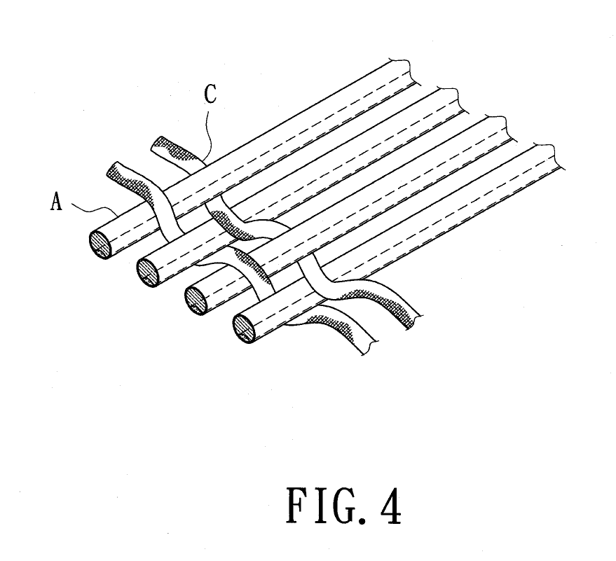

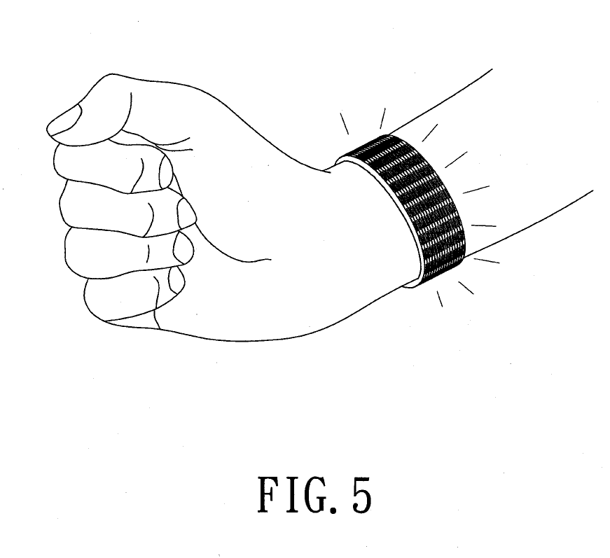

Moreover, refer to FIG. 4, the optical fiber A of the present invention is shaped into a filamentous form through drawing and is interconnected with threads C, forming a piece of cloth. The cloth is used to make clothes or is woven to form a loop used as a bracelet, as shown in FIG. 5. Or a bundle of filamentous optical fiber A is covered by a piece of cloth so as to produce various products such as shoelaces. The optical fibers mounted in an outer layer cloth of the shoelace provide glittering effects and increase product values with special effects.

Furthermore, the optical fiber A of the present invention can also be applied to optical products such as backlight modules. In applications, a plurality of optical fibers A are arranged and assembled in different ways to form backlight modules with required sizes easily. The backlight modules available now are manufactured by molds. In order to produce backlight modules with different size, a new mold is made again for each size. This leads to significant increases in the manufacturing cost. Due to high intensity and high uniformity of the optical fibers A of the present invention, common functions of the backlight module are provided and the manufacturing cost is dramatically reduced.

In addition, the optical fiber A of the present invention can also be used in vehicles. For example, the optical fiber A can be arranged around an inner circumference of a light gathering means of car lamps so as to enhance the light gathering effect of the car lamps significantly. The optical fiber A can also be used as ornaments on body side molding for increasing vividness, coolness and interest of vehicles. Or the optical fiber A is arranged around marks on the vehicle body, used as a position lamp.

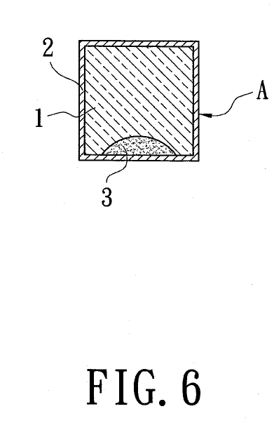

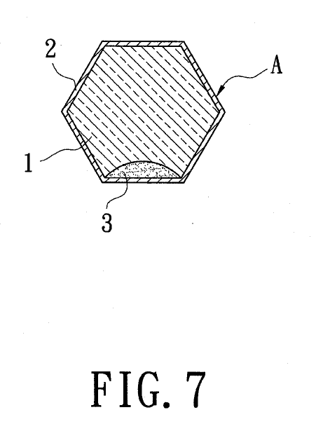

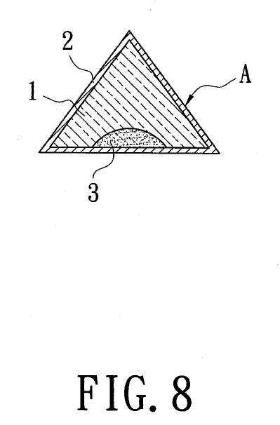

Refer from FIG. 6 to FIG. 8, other embodiments of the present invention with the optical fiber body 1 in different shapes are revealed. The cross section of the optical fiber body 1 can be round, oval, rectangular, triangular, hexagonal or polygonal for convenience of being assembled into various objects.

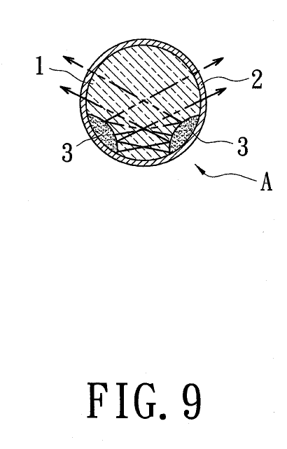

Also refer to FIG. 9, a further embodiment of the present invention is revealed. There are at least two reflectors 3 in this embodiment. When light is refracted from the refraction layer 2 to the reflector 3, the light projected onto the reflector 3 is reflected and scattered by the reflector 3 having convex surfaces. The light rays scattered from the at least two reflectors 3 cross over one another. Thus the light rays projected are with higher intensity and uniformity.

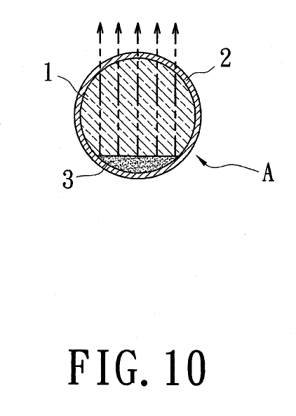

With reference of FIG. 10, a further embodiment of the present invention is disclosed. One surface of the reflector 3 that faces the inside of the optical fiber body 1 is a flat surface. Thereby, when light is refracted from the refraction layer 2 to the flat surface of the reflector 3, a plurality of reflected light rays parallel to one another are projected out. This is another lighting pattern of the optical fiber A.

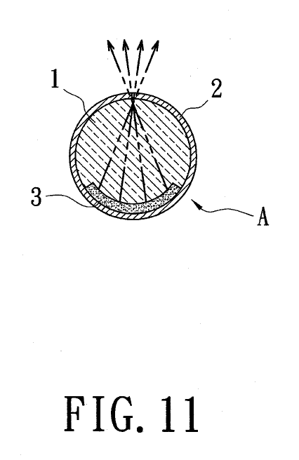

Refer to FIG. 11, a further embodiment of the present invention is disclosed. The reflector 3 is a concave curved body curved along an arc on an inner side of the optical fiber body 1. When a plurality of light rays are refracted from the refraction layer 2 to the flat surface of the reflector 3, the light rays projected onto and concentrated by the concave curved reflector 3 are reflected by the concave curved reflector 3 to be focused at one point. Thus a light beam with high brightness is generated by the optical fiber A.

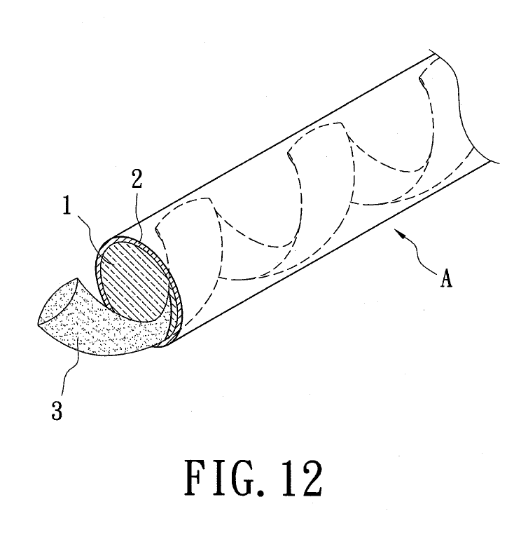

Refer to FIG. 12, a further embodiment of the present invention is revealed. During manufacturing processes of the optical fiber A, the reflector 3 is wound in a spiral form around in the optical fiber body 1. Thus after light passing through the optical fiber A and being projected, a special spiral light is generated.

In summary, the present invention has following advantages:

1. The optical fiber of the present invention is composed of an optical fiber body, a refraction layer and a reflector. After light entering the optical fiber body from one end thereof, light projected to the refraction layer is refracted to the reflector. Then a plurality of light rays are reflected by and projected out from the reflector. Thus the light intensity and uniformity of the optical fiber are significantly improved by such light gathering and light reflection effects.
2. The reflector of the optical fiber is arched up off an inner surface of the optical fiber body. Thereby after being projected to the reflector, the light is projected out in a scattering way to generate light with higher light intensity.
3. The optical fiber includes at least two reflectors that are arc-shaped with convex surfaces, like a biconvex lens. When the light projected onto the at least two reflectors is reflected, the reflected light rays cross over one another. Thus the light rays projected are with higher intensity and uniformity.
4. One side of the reflector of the optical fiber in the present invention is a flat surface. Thereby when light projected to the flat surface of the reflector, it is reflected and a plurality of light rays parallel to one another is projected out. A further light transmission pattern is provided.
5. The optical fiber of the present invention produces light with quite high intensity and uniformity. Thus when the optical fiber is applied to ornaments, advertisements and exit signs, excellent decorative, advertising and warning effects are provided.
6. The optical fiber of the present invention is produced into a filamentous form through drawing and then to be woven and interconnected with threads, forming a glittering product bringing a sense of high-quality.
7. The optical fiber of the present invention features on high light intensity and high light uniformity and can be arranged in different ways. Thus it can be easily arranged and assembled into products with different size used in backlight modules. Therefore, the cost of molds for manufacturing backlight modules with different size can be reduced.
8. The optical fiber body of the present invention is shaped into a cylinder, an elliptic cylinder or a prism such as a rectangular prism, a triangular prism, a hexagonal prism, etc so as to be assembled in and applied to various products.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A lateral guide optical fiber comprising:
an optical fiber body that is a transparent entity,
a refraction layer that covers around the optical fiber body, and
a reflector that is an opaque entity and is connected with one side of the optical fiber body.

2. The device as claimed in claim 1, wherein the reflector is a biconvex-shaped entity in which one side is convex toward an inside of the optical fiber body.

3. The device as claimed in claim 1, wherein the reflector is an arc entity concave toward an inside of the optical fiber body.

4. The device as claimed in claim 1, wherein one side of the reflector that faces an inside of the optical fiber body is a flat surface.

5. The device as claimed in claim 1, wherein the reflector is wound in a spiral form around the optical fiber body.

6. The device as claimed in claim 1, wherein the reflector includes at least two biconvex-shaped entities whose one side is convex toward an inside of the optical fiber body.

7. The device as claimed in claim 1, wherein the optical fiber body is a cylinder.

8. The device as claimed in claim 1, wherein the optical fiber body is a prism.

9. The device as claimed in claim 1, wherein the optical fiber body is in a filamentous form.
